(19) United States
(12) Patent Application Publication
(10) Pub. No.: US 2008/0288756 A1
(43) Pub. Date: Nov. 20, 2008

(54) "OR" BIT MATRIX MULTIPLY VECTOR INSTRUCTION

(76) Inventors: Timothy J. Johnson, Eau Claire, WI (US); Gregory J. Faanes, Eau Claire, WI (US)

Correspondence Address: SCHWEGMAN, LUNDBERG & WOESSNER, P.A., P.O. BOX 2938, MINNEAPOLIS, MN, 55402, US

(21) Appl. No.: 11/750,928

(22) Filed: May 18, 2007

(51) Int. Cl. G06F 9/30

(52) U.S. Cl. 712/222

(57) ABSTRACT

A processor is operable to execute a bit matrix multiply instruction. In further examples, the processor is operable to perform a vector bit matrix multiply instruction, and is a part of a computerized system.

### FEDERALLY SPONSORED RESEARCH OR DEVELOPMENT

The U.S. Government has a paid-up license in this invention and the right in limited circumstances to require the patent owner to license others on reasonable terms as provided for by the terms of Contact No. MDA904-02-3-0052, awarded by the Maryland Procurement Office.

### FIELD OF THE INVENTION

The invention relates generally to computer instructions, and more specifically to an “OR” bit matrix multiply vector instruction.

### BACKGROUND

Most general purpose computer systems are built around a general-purpose processor, which is typically an integrated circuit operable to perform a wide variety of operations useful for executing a wide variety of software. The processor is able to perform a fixed set of instructions, which collectively are known as the instruction set for the processor. A typical instruction set includes a variety of types of instructions, including arithmetic, logic, and data instructions.

Arithmetic instructions include common math functions such as add and multiply. Logic instructions include logical operators such as AND, NOT, and invert, and are used to perform logical operations on data. Data instructions include instructions such as load, store, and move, which are used to handle data within the processor.

Data instructions can be used to load data into registers from memory, to move data from registers back to memory, and to perform other data management functions. Data loaded into the processor from memory is stored in registers, which are small pieces of memory typically capable of holding only a single word of data. Arithmetic and logical instructions operate on the data stored in the registers, such as adding the data in one register to the data in another register, and storing the result in one of the two registers.

A variety of data types and instructions are typically supported in sophisticated processors, such as operations on integer data, floating point data, and other types of data in the computer system. Because the various data types are encoded into the data words stored in the computer in different ways, adding the numbers represented by two different words stored in two different registers involves different operations for integer data, floating point data, and other types of data.

For these and other reasons, it is desirable to carefully consider the data types and instructions supported in a processor's register and instruction set.

### SUMMARY

One example embodiment of the invention comprises a processor operable to execute a bit matrix multiply instruction. In further examples, the processor is operable to perform a vector bit matrix multiply instruction, and is a part of a computerized system.

### BRIEF DESCRIPTION OF THE FIGURES

FIG. 1 shows a bit matrix compare function in which a vector is compared to a bit matrix via a bit matrix multiply operation, consistent with an example embodiment of the invention.

FIG. 2 shows a vector bit matrix compare function in which two bit matrices are bit matrix compared in a vector bit matrix compare operation, consistent with some embodiments of the invention.

FIG. 3 shows a 64-by-64 bit matrix register, filled with a 20-by-20 bit matrix, as is used in an example vector bit matrix compare operation consistent with some embodiments of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

Sophisticated computer systems often use more than one processor to perform a variety of tasks in parallel, use vector processors operable to perform a specified function on multiple data elements at the same time, or use a combination of these methods. Vector processors and parallel processing are commonly found in scientific computing applications, where complex operations on large sets of data benefit from the ability to perform more than one operation on one piece of data at the same time. Vector operations specifically can perform a single function on large sets of data with a single instruction rather than using a separate instruction for each data word or pair of words, making coding and execution more straightforward. Similarly, address decoding and fetching each data word or pair of data words is typically less efficient than operating on an entire data set with a vector operation, giving vector processing a significant performance advantage when performing an operation on a large set of data.

The actual operations or instructions are performed in various functional units within the processor. A floating point add function, for example, is typically built in to the processor hardware of a floating point arithmetic logic unit, or floating point ALU functional unit of the processor. Similarly, vector operations are typically embodied in a vector unit hardware element in the processor which includes the ability to execute instructions on a group of data elements or pairs of elements. The vector unit typically also works with a vector address decoder and other support circuitry so that the data elements can be efficiently loaded into vector registers in the proper sequence and the results can be returned to the correct location in memory.

Instructions that are not available in the hardware instruction set of a processor can be performed by using the instructions that are available to achieve the same result, typically with some cost in performance. For example, multiplying two numbers together is typically supported in hardware, and is relatively fast. If a multiply instruction were not a part of a processor's instruction set, available instructions such as shift and add can be used as a part of the software program executing on the processor to compute a multiplication, but will typically be significantly slower than performing the same function in hardware.

One example embodiment of the invention seeks to speed up operation of a certain type of vector function by incorporating hardware support for an instruction to perform the function in the instruction set, extending vector instruction capability to include use of the OR function in a bit matrix functional unit. This instruction works on bit matrix data on a bit-by-bit basis, which in some embodiments is stored in a special bit matrix register or registers in the processor. This enables testing for the equality or inequality of bits in two different input bit matrices, such as to compare whether two sequences of bit-encoded data are the same.

The bit matrix vector OR function in the hardware of the vector unit is available as a bit matrix vector OR instruction in some embodiments. In other embodiments, the bit matrix vector OR function is implemented as a Vector Bit Matrix Compare, or “VBMC” instruction. The instruction is referred to as a compare function in this example because the OR function can be used to compare the contents of bits in two different bit matrices.

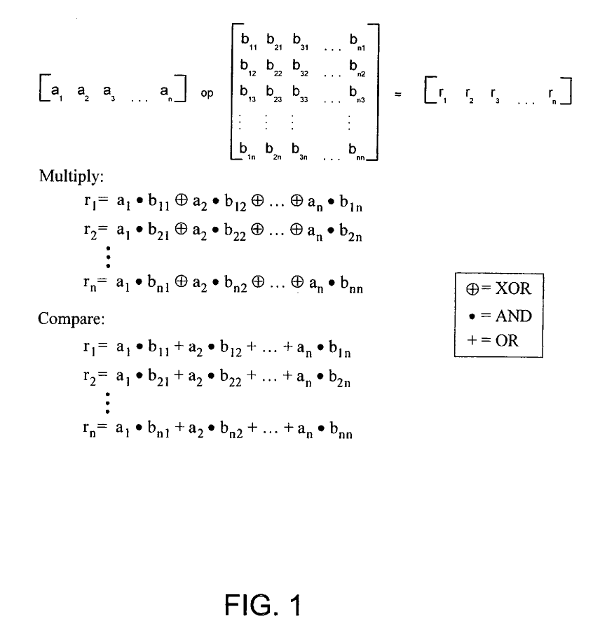

In a more detailed example shown in FIG. 1, a 1×64 bit data array A is multiplied by a 64×64 bit matrix B in a bit matrix compare operation to yield a 1×64 result matrix R. In this example, the bits of matrix B are transposed before the AND and OR operations are performed on the matrix elements, resulting in a bit matrix array R whose elements indicate whether the strings corresponding to the corresponding row in matrix A are the same as the bits in column B of transposed matrix B.

The equations used to compare the rows of matrix A to the columns of transposed matrix B are also shown in FIG. 1, which illustrates by example how to calculate several result matrix elements. As the compare result equations indicate, the first element of the result vector r1 indicates whether element a1 and b11 are the same, or whether a2 and b12 are the same, and so on. The result string therefore represents in each of its specific bit elements whether any of the elements of string a and corresponding elements of a specific column of matrix b are both one.

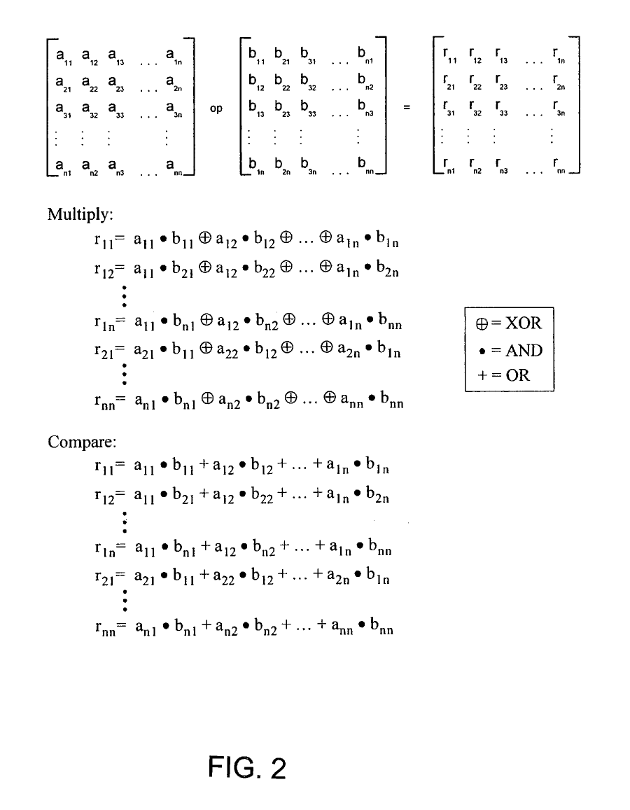

FIG. 2 illustrates a vector bit matrix compare function, in which a bit matrix a is vector bit matrix compared to a bit matrix b, and the result is shown in bit matrix r. The equations used to calculate the elements of the result matrix are also shown in FIG. 2, and illustrate that the various elements of the result matrix indicate whether any of the elements of a given row of matrix a and any elements of a given column of matrix b are both one in value.

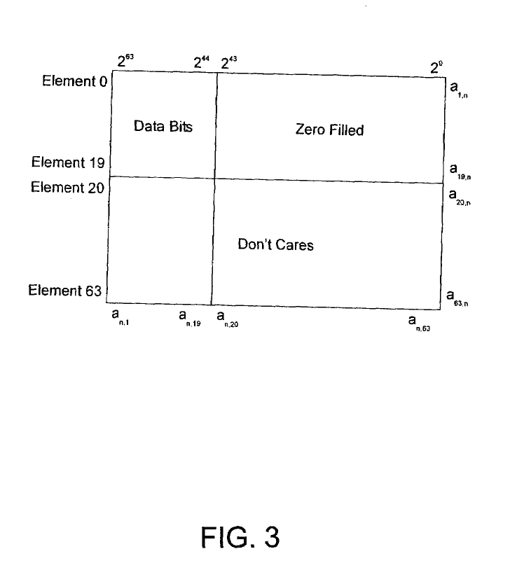

In some further embodiments, matrix arrays of a given capacity are used to store matrices of a smaller value. FIG. 3 shows an example in which a bit matrix register with a 64-bit capacity is filled with a 20-bit matrix, and the rest of the elements are filled with either zeros or with values that do not matter in calculating the final result matrix. The vector bit matrix compare result register therefore also contains a matrix of the same 20-bit size, with the remaining bits not a part of the result.

The bit matrix compare functions described herein can be implemented into the hardware functional units of a processor, such as by use of hardware logic gate networks or microcode designed to implement logic such as the equations shown in FIGS. 1 and 2. Because the bit matrix compare function is implemented in hardware, it can be executed using only a single processor instruction rather than the dozens or hundreds of instructions that would normally be needed to implement the same function on a 64-bit matrix in software. The instruction can then be used such as by using it in combination with other instructions to produce useful results for software programmers, such as by using a vector version of a bit matrix compare function in combination with a population count instruction to determine the number of bits by which a particular set of data differ from another.

This functionality has a variety of applications, such as searching for similarities or differences in genomes or other biological sequences, compressing or encrypting data, and searching large volumes of data for specific sequences. The bit matrix compare instructions implemented in hardware in processors therefore enable users of such processors to perform these functions significantly faster than was previously possible in software, meaning that a result can be achieved faster or a greater number of results can be achieved in the same amount of time.

Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A vector processor, comprising:
a bit matrix compare instruction, operable to calculate a bit matrix compare function between an array and a matrix.

2. The vector processor of claim 1, wherein the bit matrix compare instruction is a vector bit matrix compare instruction, operable to calculate a vector bit matrix compare function between two matrices.

3. The vector processor of claim 2, wherein the vector bit matrix compare instruction is implemented via a bit matrix compare functional unit in the processor.

4. The vector processor of claim 1, wherein the vector processor further comprises at least one bit matrix register.

5. The vector processor of claim 1, wherein the bit matrix compare instruction is implemented via a bit matrix compare functional unit in the processor.

6. The vector processor of claim 1, wherein the bit matrix compare instruction generates result data that is derived from OR operations on a series of AND operations, the series of AND operations performed on sequential elements of rows, columns, or arrays being bit matrix compared.

7. A method of operating a computer, comprising:
executing a bit matrix compare instruction, operable to calculate a bit matrix compare function between an array and a matrix.

8. The method of operating a computer of claim 7, wherein the bit matrix compare instruction is a vector bit matrix compare instruction, operable to calculate a vector bit matrix compare function between two matrices.

9. The method of operating a computer of claim 8, wherein the vector bit matrix compare instruction is implemented via a bit matrix compare functional unit in the processor.

10. The method of operating a computer of claim 1, wherein the vector processor further comprises at least one bit matrix register.

11. The method of operating a computer of claim 1, wherein the bit matrix compare instruction is implemented via a bit matrix compare functional unit in the processor.

12. The method of operating a computer of claim 1, wherein the bit matrix compare instruction generates result data that is derived from OR operations on a series of AND operations, the series of AND operations performed on sequential elements of rows, columns, or arrays being bit matrix compared.

13. A computerized system, comprising:
a bit matrix compare instruction, operable to calculate a bit matrix compare function between an array and a matrix.

14. The computerized system of claim 1, wherein the bit matrix compare instruction is a vector bit matrix compare instruction, operable to calculate a vector bit matrix compare function between two matrices.

15. The computerized system of claim 14, wherein the vector bit matrix compare instruction is implemented via a bit matrix compare functional unit in the processor.

16. The computerized system of claim 1, wherein the vector processor further comprises at least one bit matrix register.

17. The computerized system of claim 1, wherein the bit matrix compare instruction is implemented via a bit matrix compare functional unit in the processor.

18. The computerized system of claim 1, wherein the bit matrix compare instruction generates result data that is derived from OR operations on a series of AND operations, the series of AND operations performed on sequential elements of rows, columns, or arrays being bit matrix compared.

19. A vector processor, comprising:
a vector bit matrix compare instruction, operable to calculate a bit matrix compare function between a first matrix and a second matrix.
